(19) United States
(12) Patent Application Publication
(10) Pub. No.: US 2026/0224988 A1
(43) Pub. Date: Aug. 6, 2026

(54) SENSORY MANIPULATION IN COMPUTER DISPLAY INTERFACES

(71) Applicant: Lenovo (United States) Inc., Morrisville, NC (US)

(72) Inventors: Jujuan Mitchell, Raleigh, NC (US); Christopher Osborne, Cary, NC (US); Ada Lopez, Raleigh, NC (US); Brian Lee, Raleigh, NC (US); Dana Cockrum Gierdowski, Raleigh, NC (US); Katrina Andrews, Apex, NC (US); Brian Richardson, Columbus, GA (US); Matthew Horn, Cary, NC (US)

(21) Appl. No.: 19/047,440

(22) Filed: Feb. 6, 2025

(51) Int. Cl. A63F 13/5375; A63F 13/285; A63F 13/54; G06F 3/01; G06F 3/16

(52) U.S. Cl. CPC A63F 13/5375; A63F 13/285; A63F 13/54; G06F 3/016; G06F 3/167

(57) ABSTRACT

A computer game includes a profile of the computer game. The computer game uses the profile to provide to a player of the computer game information relating to an input device associated with the computer game. The information can be directed to a tutorial relating to the computer game or the actual playing of the computer game. The game also uses the profile to communicate to a player of the computer game a translation of a first sensory aspect of the computer game into a second sensory aspect of the computer game.

### TECHNICAL FIELD

Embodiments described herein relate to sensory manipulation in computer display interfaces, and in an embodiment, but not by way of limitation, sensory manipulation in computer gaming interfaces.

### BACKGROUND

Computer games, in their earliest forms, were introduced in the 1950s and 1960s. For example, an early, simple computer game Spacewar! consisted of two player-controlled spaceships maneuvering around a central star, which each spaceship trying to destroy the other. Since then, computer games have become exponentially more complex and graphically detailed, to the point in which most computer games include lifelike characters. However, for persons who have physical impairments, computer games can be difficult to learn to play and/or to actually play, especially in view of the ever-increasing complexity of such games.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a block diagram illustrating operations and features of a system and process to communicate information to a user of a computer system and computer system interface.

FIG. 2 is a block diagram illustrating operations and features of a system and process to manipulate sensory transmissions in a computer user interface.

FIG. 3 illustrates an example of a keyboard that can be used in connection with one or more of the disclosed embodiments.

FIG. 4 illustrates a computer display device that can be used in connection with one or more of the disclosed embodiments.

FIG. 5 illustrates a headset that can be used in connection with one or more of the disclosed embodiments.

FIG. 6 is a block diagram of a computer architecture upon which one or more of the disclosed embodiments can execute.

### DETAILED DESCRIPTION

An embodiment permits gaming to be more inclusive and accessible to all. For example, lighting on both the monitor and keyboard benefits visually impaired gamers. Sound effects and haptic sensations are another helpful distinguishing feature for users.

Further, an embodiment engages a gamer’s multiple senses. Dynamic RGB lighting on a game keyboard guides gameplay learning by assisting an early gamer in deciding which keys to press. Sound effects utilize a screen perimeter of a monitor to translate sounds into visual cues for the gamer. A headset and mouse provide haptic sensations to act as a locator to coach or aid the gamer while enriching the gaming experience for all gamers, especially visually impaired gamers.

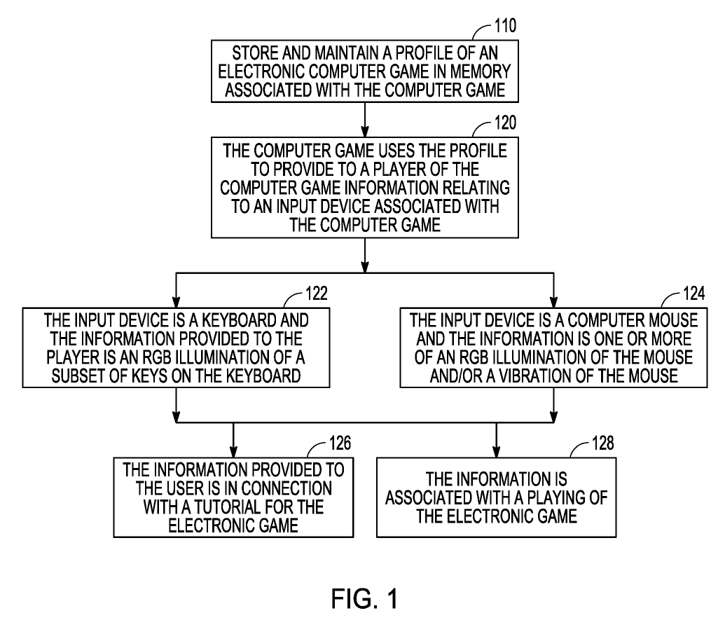

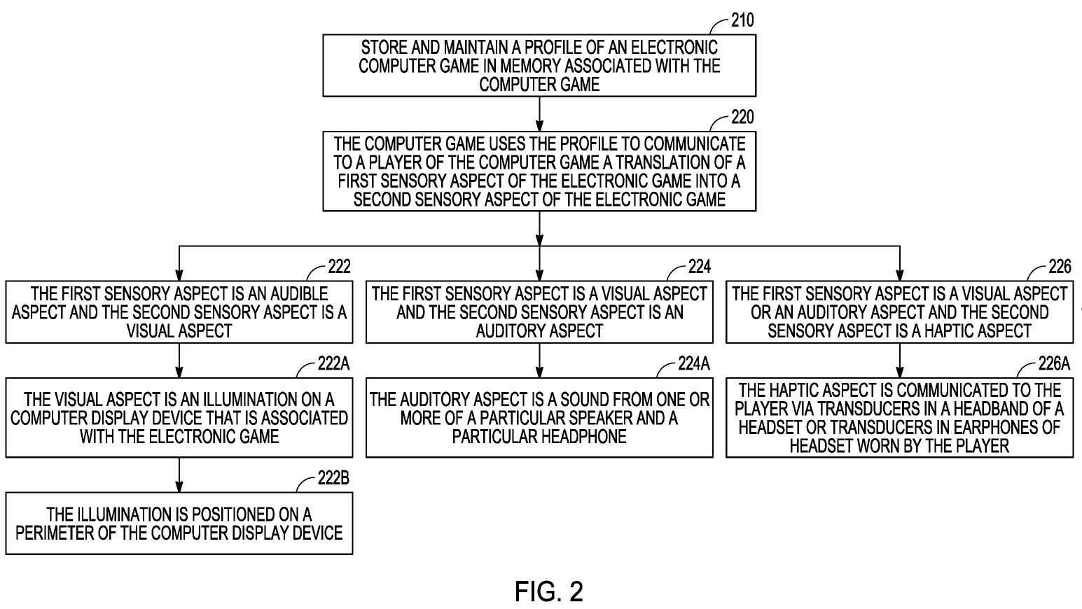

FIGS. 1 and 2 are block diagrams illustrating operations and features of a system to communicate information to a user of a computer system and an associated computer system interface, and operations and features of a system to manipulate sensory transmissions in a computer user interface, respectively. FIG. 1 includes a number of process and feature blocks 110 – 128, and FIG. 2 includes a number of process and feature blocks 200 – 226A. Though arranged substantially serially in the examples of FIGS. 1 and 2, other examples may reorder the blocks, omit one or more blocks, and/or execute two or more blocks in parallel using multiple processors or a single processor organized as two or more virtual machines or sub-processors.

Referring now to FIG. 1, at 110, a profile of an electronic computer game is stored and maintained in memory associated with the computer game. The profile can include parameters and other data relating to the execution of the computer game. At 120, the computer game uses the profile to provide to a player of the computer game information relating to an input device associated with the computer game.

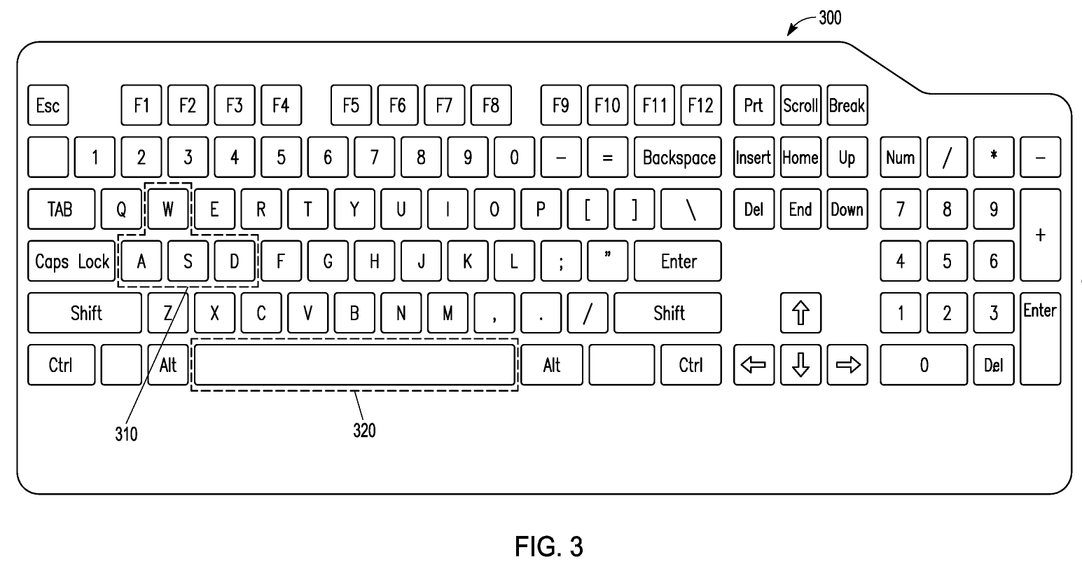

As indicated at 122, in an embodiment, the input device can be a keyboard, and the information provided to the player can be an RGB illumination of a subset of keys on the keyboard. FIG. 3 illustrates an example of a keyboard 300 in which keys 310 and the space bar 320 are illuminated. The keys 310 when pressed can be associated with the walking of a character in the computer game, and the space bar 320 can be associated with causing a character in the computer game to jump. The keys 310 and/or the space bar 320 can be illuminated to signal to the user that the keys or space bar should be depressed at a certain point in a computer game. Of course, other keys and other actions can be implemented.

Similarly, as indicated at 124, the input device can be a computer mouse, and the information can be one or more of an RGB illumination of the mouse and/or a vibration of the mouse. As indicated at 126, the information provided to the user can be in connection with a tutorial for the electronic game, or as indicated at 128 the information can be associated with a playing of the electronic game. The illumination or vibration of the mouse can be used to grab the attention of the player, and to indicate to the player that an action with the mouse is needed at that time of the tutorial or the playing of the computer game.

Referring now to FIG. 2, at 210, a profile of an electronic computer game is stored and maintained in memory associated with the computer game. At 220, the computer game uses the profile to communicate to a player of the computer game a translation of a first sensory aspect of the computer game into a second sensory aspect of the computer game.

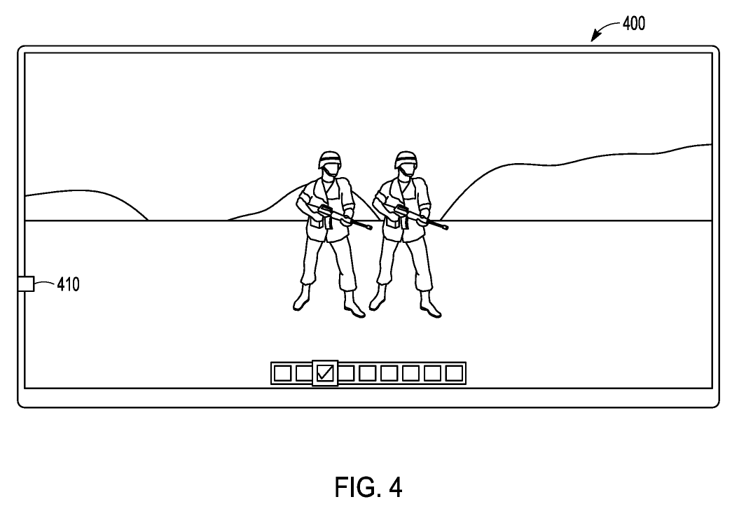

As indicated at 222, the first sensory aspect can be an audible aspect and the second sensory aspect can be a visual aspect. As further indicated as 222A, the visual aspect can be an illumination on a computer display device that is associated with the electronic game. And as still further indicated at 222B, the illumination can be positioned on a perimeter of the computer display device. FIG. 4 illustrates such a computer display device 400, wherein a sound such as an explosion is transmitted via a speaker on the left side of the computer display device. Then, in association with that sound, a bright light 410 can be illuminated on the left side of the computer display device for a particular time period such as 1 second. This bright light directs the attention of the player to the left side of the computer display device. This feature is particularly beneficial to a player who has a decreased hearing capacity.

In another embodiment, as indicated at 224, the first sensory aspect can be a visual aspect and the second sensory aspect can be an auditory aspect. And as further indicated at 224A, the auditory aspect can be a sound from one or more of a particular speaker and a particular headphone.

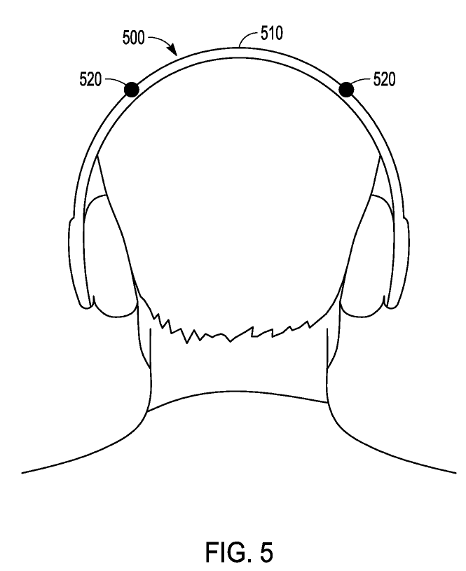

In yet another embodiment, as indicated at 226, the first sensory aspect can be a visual aspect or an auditory aspect and the second sensory aspect can be a haptic aspect. As further indicated at 226A, the haptic aspect can be communicated to the player via transducers in a headband of a headset or transducers in earphones of headset worn by the player. FIG. 5 illustrates a headset 500 in which the headband 510 of the headset 500 includes transducers 520 positioned on both sides of the headband. These transducers can communicate information to the player, such as by a vibration, and this information can direct the attention of the player towards the direction of the information.

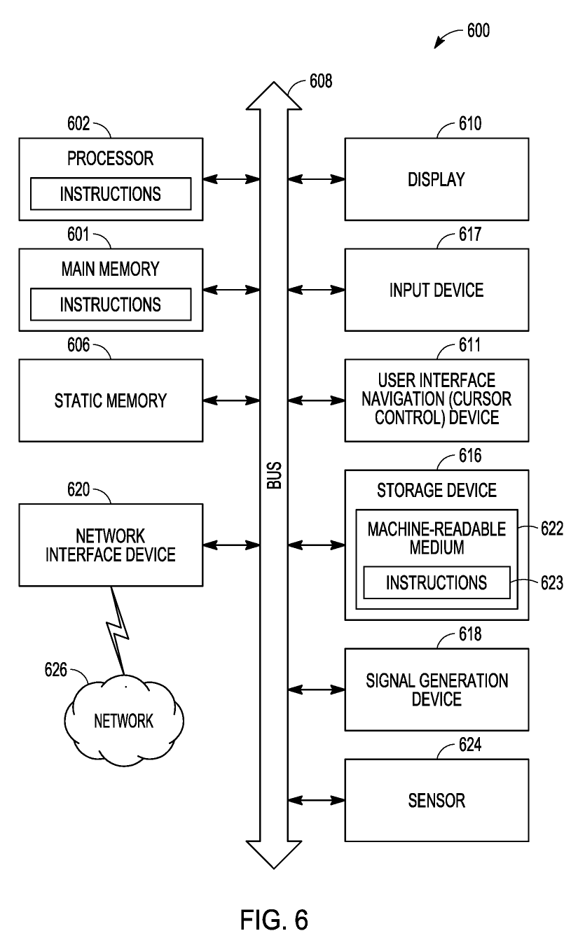

FIG. 6 is a block diagram illustrating a computing and communications platform 600 in the example form of a general-purpose machine on which some or all the operations of FIGS. 1 and 2 may be carried out according to various embodiments. In certain embodiments, programming of the computing platform 600 according to one or more particular algorithms produces a special-purpose machine upon execution of that programming. In a networked deployment, the computing platform 600 may operate in the capacity of either a server or a client machine in server-client network environments, or it may act as a peer machine in peer-to-peer (or distributed) network environments.

Example computing platform 600 includes at least one processor 602 (e.g., a central processing unit (CPU), a graphics processing unit (GPU) or both, processor cores, compute nodes, etc.), a main memory 601 and a static memory 606, which communicate with each other via a link 608 (e.g., bus). The computing platform 600 may further include a video display unit 610, input devices 617 (e.g., a keyboard, camera, microphone), and a user interface (UI) navigation device 611 (e.g., mouse, touchscreen). The computing platform 600 may additionally include a storage device 616 (e.g., a drive unit), a signal generation device 618 (e.g., a speaker), a sensor 624, and a network interface device 620 coupled to a network 626.

The storage device 616 includes a non-transitory machine-readable medium 622 on which is stored one or more sets of data structures and instructions 623 (e.g., software) embodying or utilized by any one or more of the methodologies or functions described herein. The instructions 623 may also reside, completely or at least partially, within the main memory 601, static memory 606, and/or within the processor 602 during execution thereof by the computing platform 600, with the main memory 601, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 623. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### Examples

Example No. 1 is a process comprising maintaining in a computer processor a profile of an electronic game; and using the profile of the electronic game to provide to a player of the electronic game information relating to an input device associated with the electronic game.

Example No. 2 includes all the features of Example No. 1, and optionally includes a process wherein the input device comprises a keyboard, and wherein the information comprises an RGB illumination of a subset of keys on the keyboard.

Example No. 3 includes all the features of Example Nos. 1-2, and optionally includes a process wherein the input device comprises a mouse, and wherein the information comprises one or more of an RGB illumination of the mouse and a vibration of the mouse.

Example No. 4 includes all the features of Example Nos. 1-3, and optionally includes a process wherein the information comprises a tutorial for the electronic game.

Example No. 5 includes all the features of Example Nos. 1-4, and optionally includes a process wherein the information is associated with a playing of the electronic game.

Example No. 6 is a process comprising maintaining in a computer processor a profile of an electronic game; and using the profile of the electronic game to communicate to a player of the electronic game a translation of a first sensory aspect of the electronic game into a second sensory aspect of the electronic game.

Example No. 7 includes all the features of Example No. 6 and optionally includes a process wherein the first sensory aspect comprises an audible aspect and the second sensory aspect comprises a visual aspect.

Example No. 8 includes all the features of Example Nos. 6-7 and optionally includes a process wherein the visual aspect comprises an illumination on a computer display device associated with the electronic game.

Example No. 9 includes all the features of Example Nos. 6-8 and optionally includes a process wherein the illumination is positioned on a perimeter of the computer display device.

Example No. 10 includes all the features of Example Nos. 6-9 and optionally includes a process wherein the first sensory aspect comprises a visual aspect and the second sensory aspect comprises an auditory aspect.

Example No. 11 includes all the features of Example Nos. 6-10 and optionally includes a process wherein the auditory aspect comprises a sound from one or more of a particular speaker and a particular headphone.

Example No. 12 includes all the features of Example Nos. 6-11 and optionally includes a process wherein the first sensory aspect comprises a visual aspect or an auditory aspect and the second sensory aspect comprises a haptic aspect.

Example No. 13 includes all the features of Example Nos. 6-12 and optionally includes a process wherein the haptic aspect is communicated to the player via transducers in a headband of a headset or transducers in earphones of headset worn by the player.

Example No. 14 is a system comprising a computer processor; a memory coupled to the computer processor; and a computer display device coupled to the computer processor wherein the system is operable for maintaining in the computer processor a profile of the system; and using the profile of the system to communicate to a user of the system a translation of a first sensory aspect generated by the system game into a second sensory aspect.

Example No. 15 includes all the features of Example No. 14, and optionally includes a system wherein the system comprises a computer game.

Example No. 16 includes all the features of Example Nos. 14-15, and optionally includes a system wherein the first sensory aspect comprises an audible aspect and the second sensory aspect comprises a visual aspect; and wherein the visual aspect comprises an illumination on the computer display device associated with the system.

Example No. 17 includes all the features of Example Nos. 14-16, and optionally includes a system wherein the illumination is positioned on a perimeter of the computer display device.

Example No. 18 includes all the features of Example Nos. 14-17, and optionally includes a system wherein the first sensory aspect comprises a visual aspect and the second sensory aspect comprises an auditory aspect.

Example No. 19 includes all the features of Example Nos. 14-18, and optionally includes a system wherein the auditory aspect comprises a sound from one or more of a particular speaker and a particular headphone.

Example No. 20 includes all the features of Example Nos. 14-19, and optionally includes a system wherein the first sensory aspect comprises a visual aspect or an auditory aspect and the second sensory aspect comprises a haptic aspect; and wherein the haptic aspect is communicated to the user via transducers in a headband of a headset or transducers in earphones of headset worn by the user.

1. A process comprising:
maintaining in a computer processor a profile of an electronic game; and
using the profile of the electronic game to provide to a player of the electronic game information relating to an input device associated with the electronic game.

2. The process of claim 1, wherein the input device comprises a keyboard, and wherein the information comprises an RGB illumination of a subset of keys on the keyboard.

3. The process of claim 1, wherein the input device comprises a mouse, and wherein the information comprises one or more of an RGB illumination of the mouse and a vibration of the mouse.

4. The process of claim 1, wherein the information comprises a tutorial for the electronic game.

5. The process of claim 1, wherein the information is associated with a playing of the electronic game.

6. A process comprising:
maintaining in a computer processor a profile of an electronic game; and
using the profile of the electronic game to communicate to a player of the electronic game a translation of a first sensory aspect of the electronic game into a second sensory aspect of the electronic game.

7. The process of claim 6, wherein the first sensory aspect comprises an audible aspect and the second sensory aspect comprises a visual aspect.

8. The process of claim 7, wherein the visual aspect comprises an illumination on a computer display device associated with the electronic game.

9. The process of claim 8, wherein the illumination is positioned on a perimeter of the computer display device.

10. The process of claim 6, wherein the first sensory aspect comprises a visual aspect and the second sensory aspect comprises an auditory aspect.

11. The process of claim 10, wherein the auditory aspect comprises a sound from one or more of a particular speaker and a particular headphone.

12. The process of claim 6, wherein the first sensory aspect comprises a visual aspect or an auditory aspect and the second sensory aspect comprises a haptic aspect.

13. The process of claim 12, wherein the haptic aspect is communicated to the player via transducers in a headband of a headset or transducers in earphones of headset worn by the player.

14. A system comprising:
a computer processor;
a memory coupled to the computer processor; and
a computer display device coupled to the computer processor;
wherein the system is operable for:
maintaining in the computer processor a profile of the system; and
using the profile of the system to communicate to a user of the system a translation of a first sensory aspect generated by the system into a second sensory aspect.

15. The system of claim 14, wherein the system comprises a computer game.

16. The system of claim 14, wherein the first sensory aspect comprises an audible aspect and the second sensory aspect comprises a visual aspect; and wherein the visual aspect comprises an illumination on the computer display device.

17. The system of claim 16, wherein the illumination is positioned on a perimeter of the computer display device.

18. The system of claim 14, wherein the first sensory aspect comprises a visual aspect and the second sensory aspect comprises an auditory aspect.

19. The system of claim 18, wherein the auditory aspect comprises a sound from one or more of a particular speaker and a particular headphone.

20. The system of claim 14, wherein the first sensory aspect comprises a visual aspect or an auditory aspect and the second sensory aspect comprises a haptic aspect; and wherein the haptic aspect is communicated to the user via transducers in a headband of a headset or transducers in earphones of the headset worn by the user.
